(19) United States
(12) Patent Application Publication
(10) Pub. No.: US 2014/0119251 A1
(43) Pub. Date: May 1, 2014

(54) INFORMATION SERVICE SYSTEM USING DIRECT COMMUNICATION BETWEEN VEHICLES

(71) Applicant: Electronics and Telecommunications Research Institute, Daejeon (KR)

(72) Inventors: Jung-Soo PARK, Daejeon (KR); Hyoung-Jun KIM, Daejeon (KR)

(73) Assignee: Electronics and Telecommunications Research Institute, Daejeon (KR)

(21) Appl. No.: 14/023,545

(22) Filed: Sep. 11, 2013

(30) Foreign Application Priority Data
Oct. 25, 2012 (KR) 10-2012-0119012

(51) Int. Cl. H04W 76/02; H04W 88/16

(52) U.S. Cl. CPC H04W 76/023; H04W 88/16
USPC 370/310

(57) ABSTRACT

Disclosed herein is an information service system using direct communication between vehicles for machine-to-machine (M2M)-based intelligent transport services (ITS). The information service system includes at least one vehicle ITS station and at least one roadside device. The vehicle station and the roadside device exchange information with a server. The vehicle ITS station includes an ITS-S host configured to perform overall control, an ITS-S router configured to connect with a short or long distance communication network, to form a communication network, and to perform transmission and reception of data, and a vehicle ITS-S gateway configured to provide data received from an outside of the vehicle ITS station, that is, data provided from an electronic control unit (ECU) or a variety of types of sensors on a vehicle. The ITS-S host, the ITS-S router and the vehicle ITS-S gateway are connected over an ITS station-internal network, thereby forming a vehicle-mounted device.

### CROSS REFERENCE TO RELATED APPLICATION

This application claims the benefit of Korean Patent Application No. 10-2012-0119012, filed on Oct. 25, 2012, which is hereby incorporated by reference in its entirety into this application.

### BACKGROUND OF THE INVENTION

1. Technical Field

The present invention relates generally to an information service system and, more particularly, to an information service system using direct communication between vehicle-mounted devices, which makes use of a machine-to-machine (M2M) communication-based intelligent transport system (ITS), can provide vehicle-related information via a roadside device and collect information from vehicles, and enables information to be propagated and collected via direct communication between the vehicles.

2. Description of the Related Art

M2M (also called machine type communication (MTC)) is technology that enables information to be exchanged between devices without the manipulation of a user, thereby providing an easy information service. This technology is a background technology for an ITS that provides vehicle-related information over a general communication network including a local area network or the wireless Internet.

As a conventional technology, Korean Patent Application Publication No. 10-2012-0055832 A discloses a vehicle group management and vehicle group registration method for the provision of vehicle location service, which is illustrated in FIG. 1. This method includes transmitting, by the group reader node of a vehicle group, a group reader advertising message to at least one vehicle node of the vehicle group; if the group reader node receives a group reader registration message from a vehicle node that is travelling in the same direction as the group reader node in response to the group reader advertising message, registering, by the group reader node, the vehicle node that has transmitted the group reader registration message as a member vehicle node of the vehicle group; and transmitting, by the group reader node, information of the vehicle group to a local head, that is, a fixed location server disposed in each unit area.

As another conventional technology, International Publication No. WO 2005/106823 A1 discloses a method and system using a programmable sign display that is disposed adjacent to a traffic signal, which is illustrated in FIG. 2. The system includes a programmable sign display disposed adjacent to a traffic signal and configured to respond to provide a display of information to drivers according to programming; and a wireless interface disposed between a communication network and the programmable sign display. The wireless interface transfers a program from the communication network to the programmable sign display, and provides a display of information to drivers who pay attention to the traffic signal.

As still another conventional technology, there is an advertising system, which is illustrated in FIG. 3. In this system, a server unit stores different pieces of advertising information for respective advertising areas, and a server determines the geographical location of a vehicle and provides corresponding advertising information.

As yet another conventional technology, Japanese Unexamined Patent Application Publication No. 2010-140036 A discloses an information provision server, a program, and an information processing method, which are illustrated in FIG. 4. This server is an information provision server that is capable of communicating with one or more vehicle-mounted devices that are mounted on vehicles. The server includes a storage unit configured to store advertising information groups, including map-added information and a plurality of pieces of advertising information, and location information, indicating predetermined advertising output locations, so that they are associated with each other, an information processing unit configured to set the advertising information groups to be transmitted to the vehicle-mounted devices for communication devices having different coverage ranges, and a transmission unit configured to transmit the advertising information groups and the location information set by the information processing unit to the communication devices. The information provision server can deal with the map-added information for locations remote from the coverage ranges of the communication devices, and may delete and add an advertising information group from and to the advertising information groups stored in the storage unit.

The above-described conventional technologies are configured to provide information to vehicles in a unilateral manner, and are disadvantageous in that they cannot achieve the efficiency of information transfer and cannot respond to information requests from vehicles that receive the information.

### SUMMARY OF THE INVENTION

The present invention is intended to provide an information service system using direct communication between vehicles, which can provide information from a server through a roadside device to vehicle-mounted devices, and can propagate the information via direct communication between the vehicle-mounted devices.

The present invention is intended to provide an information service system using direct communication between vehicles, which can collect information from vehicle-mounted devices through a roadside device, and can provide the collected information to a server.

The present invention is intended to provide an information service system using direct communication between vehicles, in which vehicle-mounted devices are assigned credits in return for the propagation of information provided from the server and the provision of information, and can receive necessary information from the server using the credits.

In accordance with the present invention, there are provided information service systems using direct communication between vehicles for M2M-based intelligent transport services, including at least one vehicle ITS station and at least one roadside device, wherein the vehicle station and the roadside device exchange information with a server, and message formats for the information service systems.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates the configuration of a conventional vehicle group management and vehicle group registration method for the provision of vehicle location service;

FIG. 2 illustrates the configuration of a conventional method and system using a programmable sign display that is disposed adjacent to a traffic light;

FIG. 3 illustrates the configuration of a conventional advertising system;

FIG. 4 illustrates the configuration of a conventional information provision server, a conventional program, and a conventional information processing method;

FIG. 5 illustrates the configuration of a vehicle-mounted device according to the present invention;

FIG. 6 illustrates the configuration of a roadside device according to the present invention;

FIG. 7 illustrates an example of the first step of a procedure for ID assignment and security information provision for the propagation of information;

FIG. 8 illustrates another example of the first step of the procedure for ID assignment and security information provision for the propagation of information;

FIG. 9 illustrates an example of the second step of the procedure for ID assignment and security information provision for the propagation of information;

FIG. 10 illustrates a configuration for the propagation of information in the system using direct communication between vehicles according to an embodiment of the present invention;

FIG. 11 illustrates a configuration for the processing of advertising information in the system using direct communication between vehicles according to an embodiment of the present invention;

FIG. 12 illustrates a configuration for the processing of credits in the system using direct communication between vehicles according to an embodiment of the present invention;

FIG. 13 illustrates a configuration for the processing of information collection in the system using direct communication between vehicles according to an embodiment of the present invention;

FIG. 14 illustrates a configuration for the assignment of credits based on the processing of information collection;

FIGS. 15 and 16 illustrate a configuration for providing a credit from a vehicle-mounted device and receiving an information service from a server;

FIG. 17 illustrates an example of a general message format that is used in the information service system using direct communication between vehicles according to the present invention;

FIG. 18 illustrates an example of an IDEN type message format;

FIG. 19 illustrates an example of an IACK type message format;

FIG. 20 illustrates an example of a DATA type message format;

FIG. 21 illustrates an example of a DACK type message format;

FIG. 22 illustrates an example of an ANNO type message format; and

FIG. 23 illustrates an example of an AACK type message format.

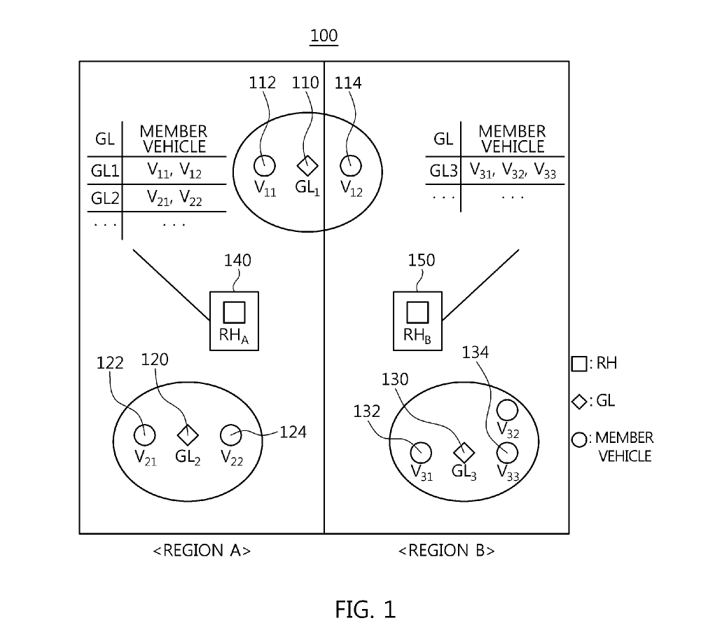

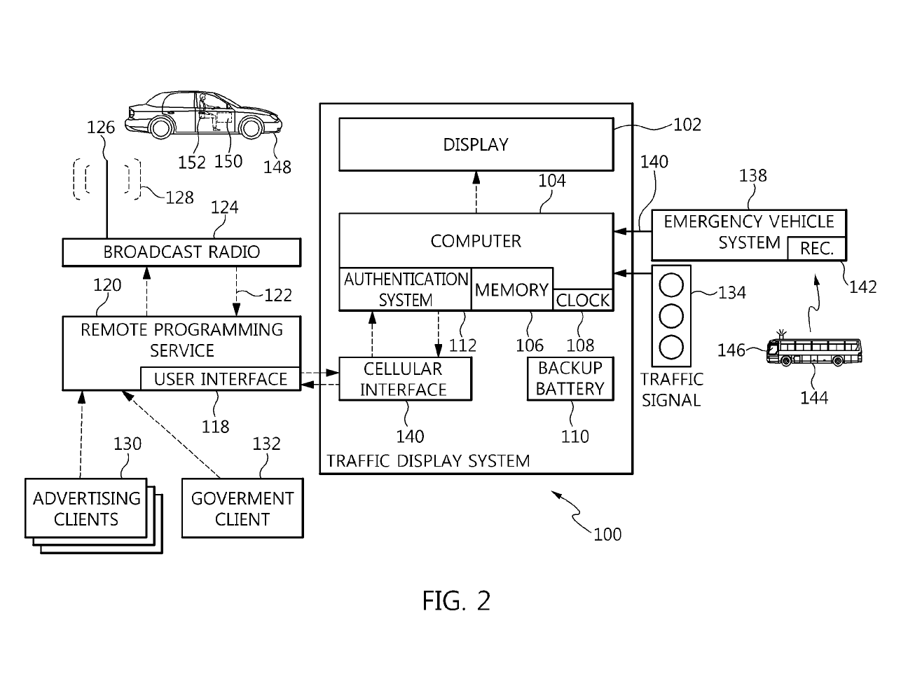

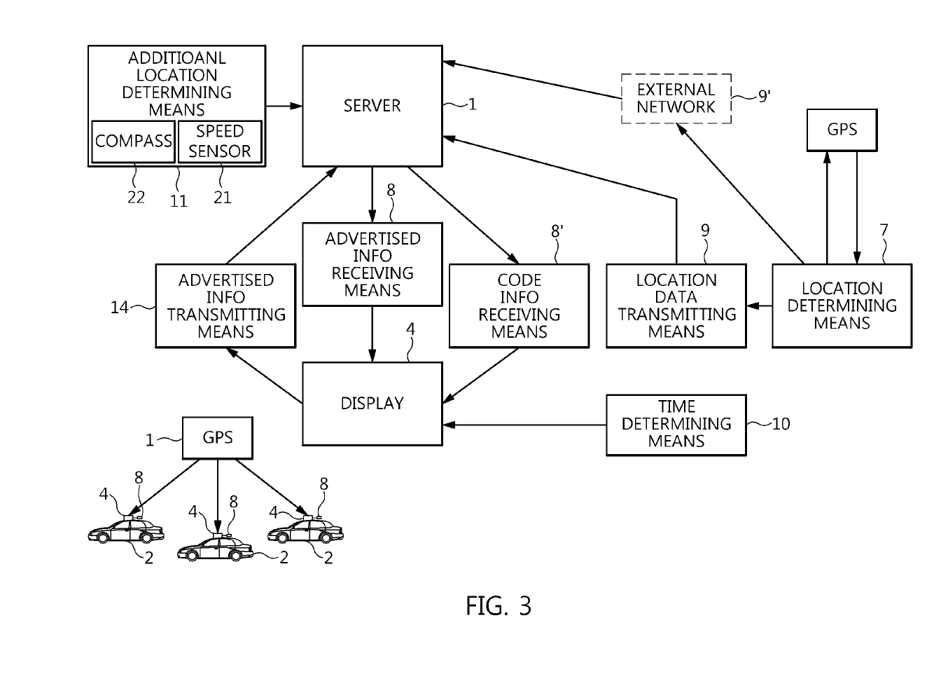

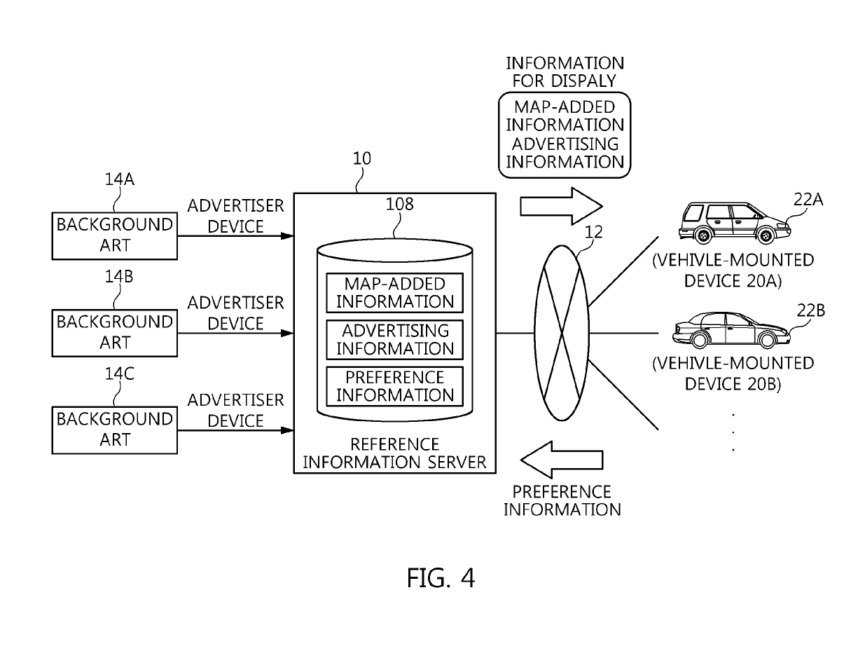

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

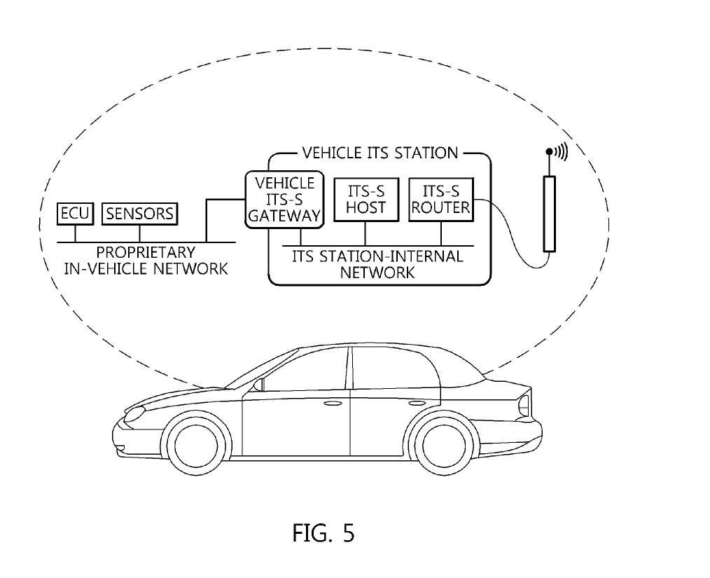

FIG. 5 illustrates the configuration of a vehicle-mounted device according to the present invention. The vehicle-mounted device for an information service system using direct communication between vehicles according to the present invention is a vehicle ITS station for an ITS, and includes an ITS-S host configured to be responsible for the overall control of the vehicle-mounted device and an ITS-S router connected to the ITS-S host over an ITS station-internal network. The ITS-S router connects with a short or long distance communication network, forms a communication network, and performs the transmission and reception of data. Furthermore, a vehicle ITS-S gateway is connected to the ITS station-internal network. The vehicle ITS-S gateway provides data provided from the outside of the vehicle ITS station (that is, the vehicle-mounted device), that is, data provided from an electronic control unit (ECU) or a variety of types of sensors on a vehicle, to the vehicle-mounted device.

The ECU and the variety of types of sensors on a vehicle that provide data from the outside of the vehicle-mounted device form a proprietary in-vehicle network, and are connected to the vehicle ITS-S gateway. In this case, the network is provided as a proprietary in-vehicle network that is previously registered to ensure the compatibility of external network access via the vehicle-mounted device.

Accordingly, the vehicle-mounted device according to the present invention may transmit the information of the ECU and the sensors inside the vehicle to the outside via the vehicle ITS station, and the vehicle-mounted device may provide information provided from the outside via the ITS-S router to the vehicle via the ITS-S gateway.

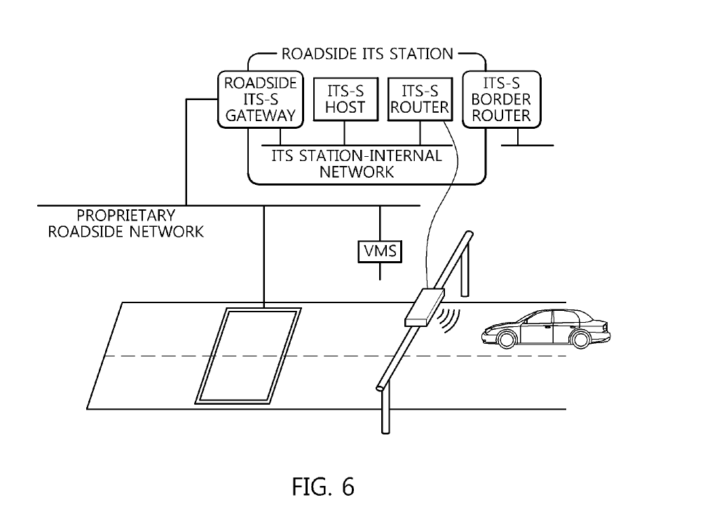

FIG. 6 illustrates the configuration of a roadside device according to the present invention. The roadside device for the information service system using direct communication between vehicles according to the present invention is a roadside ITS station for an ITS, and includes an ITS-S host configured to perform the overall control of the roadside device and an ITS-S router connected to the ITS-S host over an ITS station-internal network. The ITS-S router connects with a short or long distance communication network, forms a communication network, and transmits and receives data to and from vehicles that are travelling along a road. Furthermore, a roadside ITS-S gateway is connected to the ITS station-internal network. The roadside ITS-S gateway provides data provided from the outside of the roadside device, that is, data provided from a sensor, such as a detector, to the roadside device over a roadside network, and displays information provided from the roadside device on VMS (variable message signs) via the roadside network. Furthermore, an ITS-S border router is connected to the ITS station-internal network. The ITS-S border router connects roadside devices to a network, and these roadside devices are connected to the central server of the ITS.

Accordingly, the vehicle-mounted device of FIG. 5 cannot only exchange information with the roadside device of FIG. 6 via the ITS-S router, but vehicle-mounted devices can also exchange information with each other.

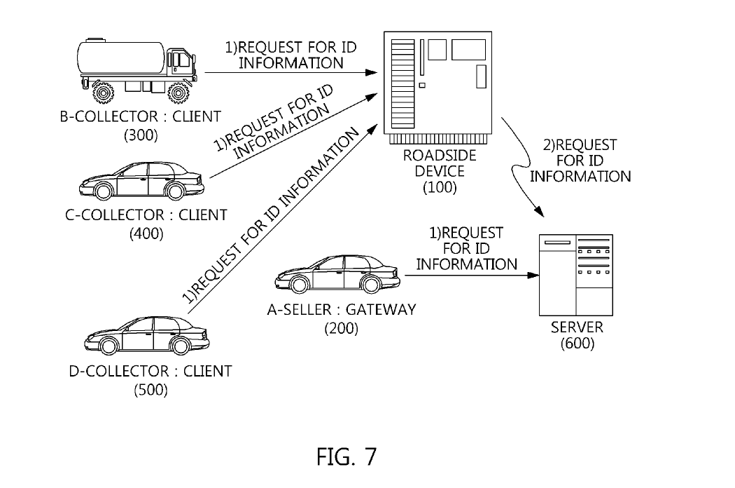

FIG. 7 illustrates an example of the first step of a procedure for ID assignment and security information provision for the propagation of information in the system using direct communication between vehicles according to an embodiment of the present invention. Although the type of information that is provided by the information service system according to the present invention is not limited, the following description will be given using advertizing information as an example of the provided information so as to clarify the features of the present invention. Accordingly, it should be appreciated that information that is provided by the information service system according to the present invention is not limited only to advertising information.

First, ID information requests are transmitted from vehicles, mounted with vehicle-mounted devices having their own networking function, such as ZigBee, and illustrated as a B-collector 300, a C-collector 400, and a D-collector 500 to the roadside device 100 according to the present invention. The roadside device 100 that has received the ID information requests transmits ID information request information to the server 600 of the information service system. Meanwhile, if a vehicle-mounted device has an IP networking function, an A-seller 200 illustrated in the drawing may request identification information via direct communication with a server 600. For this purpose, a communication module configured to communicate with an external network, such as a 3GPP network, is included in the vehicle ITS-S gateway inside the vehicle-mounted device illustrated in FIG. 5.

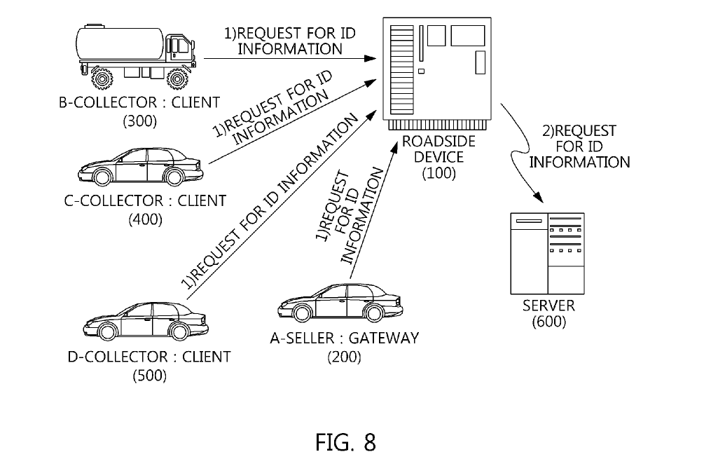

FIG. 8 illustrates another example of the first step of the procedure for ID assignment and security information provision for the propagation of information in the system using direct communication between vehicles according to an embodiment of the present invention.

First, ID information requests are transmitted from vehicles, mounted with vehicle-mounted devices having their own networking function, such as ZigBee, and illustrated as an A-seller 200, a B-collector 300, a C-collector 400, and a D-collector 500, to the roadside device 100 according to the present invention. The roadside device 100 that has received the ID information requests transmits ID information request information to the server 600 of the information service system.

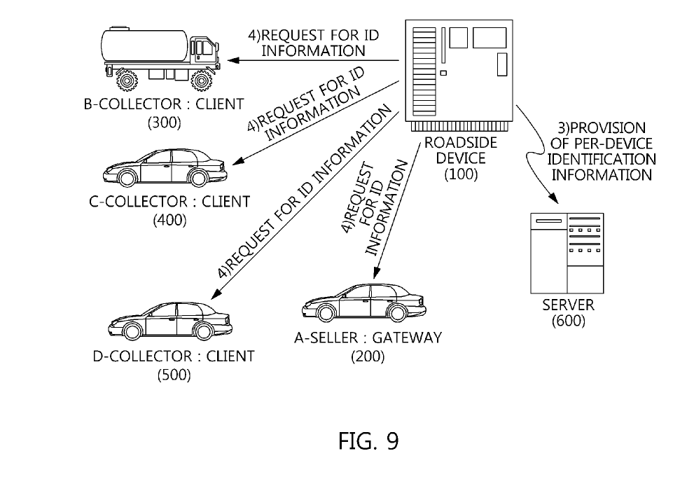

FIG. 9 illustrates an example of the second step of the procedure for ID assignment and security information provision for the propagation of information in the system using direct communication between vehicles according to an embodiment of the present invention. As illustrated in FIG. 8, when the ID information request information is transmitted to the server 600 of the information service system by the roadside device 100 that has received the ID information requests from the vehicles mounted with the vehicle-mounted devices, the server 600 of the information service system assigns identification information to each vehicle-mounted device, and transmits the per-vehicle-mounted device identification information and security information to the roadside device 100. Thereafter, the roadside device 100 provides the per-vehicle-mounted device identification information and security information to each corresponding vehicle-mounted device that transmitted the ID information request, so that the vehicle-mounted devices can be distinguished from each other for respective vehicles.

In this case, when a vehicle-mounted device is equipped with an IP networking function because a communication module configured to communicate with an external network, such as a 3GPP network, is included in its vehicle ITS-S gateway and the vehicle-mounted device requests identification information from the server 600 via direct communication, as illustrated in FIG. 7, the server 600 of the information service system transmits identification information and security information directly to the vehicle-mounted device (not illustrated).

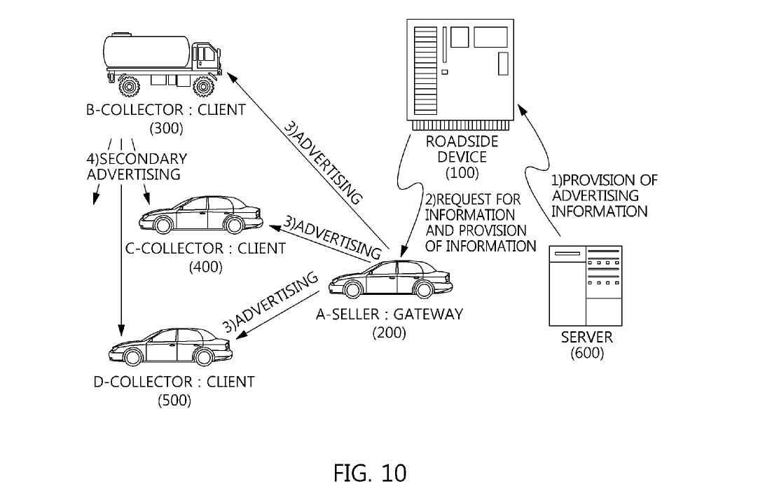

FIG. 10 illustrates a configuration for the propagation of information in the system using direct communication between vehicles according to an embodiment of the present invention. After the above-described procedure for ID assignment and security information provision for the propagation of information in the system using direct communication between vehicles has been performed, the server 600 transmits advertising information to the roadside device 100. In this case, the roadside device 100 provides advertising information, together with an information request, to an adjacent vehicle mounted with a vehicle-mounted device. The vehicle mounted with the vehicle-mounted device (illustrated as an A-seller 200 in the drawing) that has received the advertising information displays or plays the received advertising information, and transmits the advertising information, together with an assigned ID, to adjacent vehicles. Each of the vehicles that have received the advertising information, in turn, transmits the advertising information, including the assigned ID of its vehicle-mounted device and the ID included in the received advertising information, to other adjacent vehicles.

According to this propagation structure, advertising information is received two or more times depending on the vehicle mounted with the vehicle-mounted device. As illustrated in FIG. 10, a C-collector 400 and a D-collector 500 receive advertising information via the A-seller 200, and also receive advertising information via a B-collector 300. If the advertising information is redundant, the vehicles mounted with the vehicle-mounted devices may selectively display or play the advertising information only once.

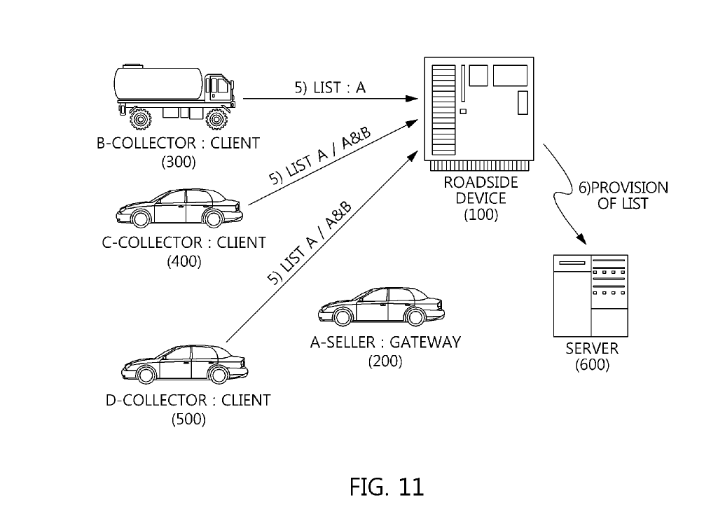

FIG. 11 illustrates a configuration for the processing of advertising information in the system using direct communication between vehicles according to an embodiment of the present invention. Once the advertising information has been transmitted to the vehicles mounted with vehicle-mounted devices, as illustrated in FIG. 10, the vehicle-mounted device of each of the vehicles transmits a list for the processing of the advertising information to the roadside device 100. Furthermore, if the vehicles mounted with the vehicle-mounted devices approach the roadside device 100 or other vehicles mounted with vehicle-mounted devices, they transmit a list for the processing of advertising information.

Here, the list to be transmitted includes the identification information of the vehicle-mounted device to which the advertising information has been transferred. If the advertising information is propagated, as illustrated in FIG. 10, the identification information of all the vehicle-mounted devices that propagate the advertising information is included in the list. By way of example, referring to FIGS. 10 and 11 together, the B-collector 300 transmits the identification information of the A-seller 200 to the roadside device 100 in the form of a list because the B-collector 300 has received the advertising information from the A-seller 200. The C-collector 400 and the D-collector 500 transmit the identification information of the A-seller 200 and the B-collector 300 to the roadside device 100 in the form of a list because the C-collector 400 and the D-collector 500 have received the advertising information from the A-seller 200 and the B-collector 300.

The roadside device 100 that has received the list from each of the vehicles mounted with the vehicle-mounted devices provides the list to the server 600.

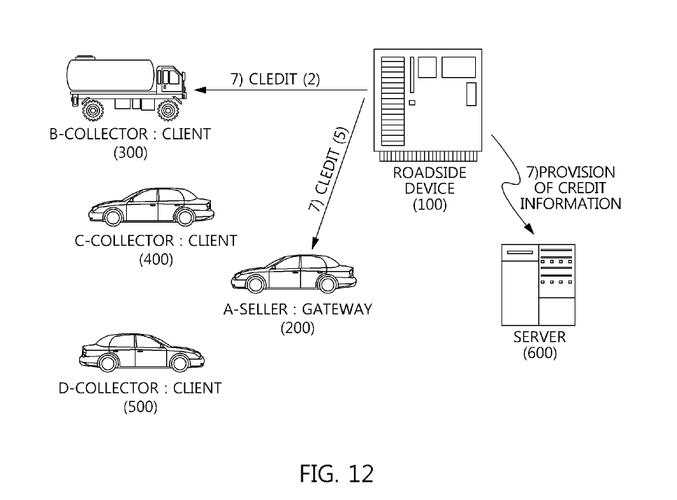

FIG. 12 illustrates a configuration for the processing of credits in the system using direct communication between vehicles according to an embodiment of the present invention. The roadside device 100 that has received the lists as a result of the processing of the advertising information illustrated in FIG. 11 calculates the number of transmissions of the advertising information based on the per-vehicle-mounted device lists, calculates credits based on the results of the calculation, transmits per-vehicle-mounted device credits to the server 600, and transmits the calculated per-vehicle-mounted device credits to the corresponding vehicle-mounted devices. In the example illustrated in the drawings, a credit corresponding to 2 is assigned to the B-collector 300 because the B-collector 300 has transferred the received advertising information to two vehicle-mounted devices, that is, the C-collector 400 and the D-collector 500. Furthermore, a credit corresponding to 5 is assigned to the A-seller 200 because the A-seller 200 has transferred the advertising information to three vehicle-mounted devices, that is, the B-collector 300, the C-collector 400 and the D-collector 500, and the B-collector 300 has transferred the received advertising information to two vehicle-mounted devices, that is, the C-collector 400 and the D-collector 500. The credits are transmitted to and stored in the corresponding vehicle-mounted devices and used in the vehicles mounted with the corresponding vehicle-mounted devices. The configuration and operation related to this will be described later.

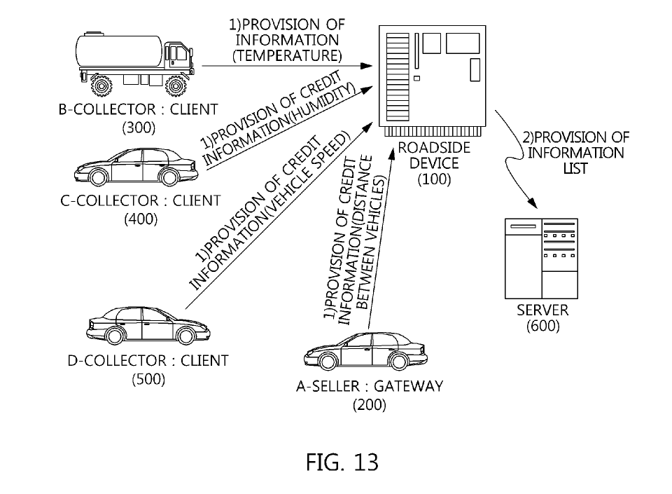

FIG. 13 illustrates a configuration for the processing of information collection in the system using direct communication between vehicles according to an embodiment of the present invention.

As described above, data provided from the outside of the vehicle-mounted device, that is, data provided from an ECU or a variety of types of sensor on a vehicle side, may be transferred from the vehicle-mounted device to the roadside device 100 via the vehicle ITS-S gateway connected to the ITS station-internal network of the vehicle-mounted device. Accordingly, the data provided from the vehicles, together with the IDs of the vehicle-mounted devices, are transmitted from the vehicles illustrated as the A-collector 200, the B-collector 300, the C-collector 400, and the D-collector 500 mounted with the vehicle-mounted devices to the roadside device 100. The data provided from the vehicles is all data for intelligent transport services, and includes information about temperature, humidity, vehicle speed, the distance between vehicles, and the like. The roadside device 100 that has received the data provided from the vehicles provides the received information and the IDs of the vehicle-mounted devices to the server 600 in the form of lists, so that the lists are stored therein.

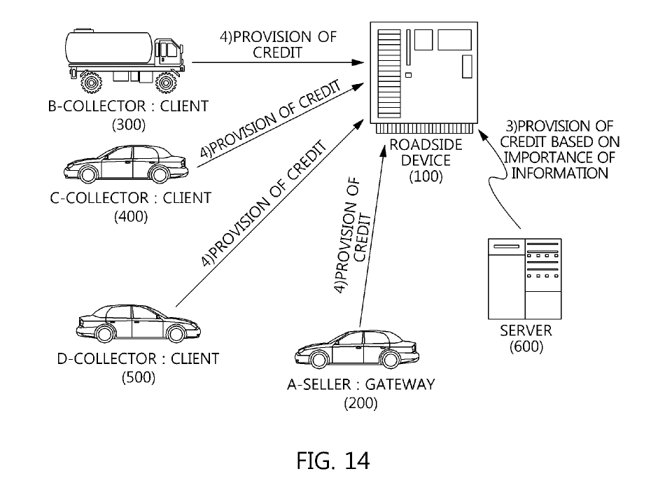

FIG. 14 illustrates a configuration for the assignment of credits based on the processing of information collection illustrated in FIG. 13. In the information service system according to the present invention, when the server 600 that stores the data provided from the vehicles and the IDs of the vehicle-mounted device that have provided the information based on the processing of information collection in the form of information lists assigns a credit to each of the vehicle-mounted devices depending on the importance of provided information and transmits the credit to the roadside device 100, the roadside device 100 transmits the credit to the corresponding vehicle-mounted device, and the vehicle-mounted device that has received the credit stores the received credit in the vehicle-mounted device.

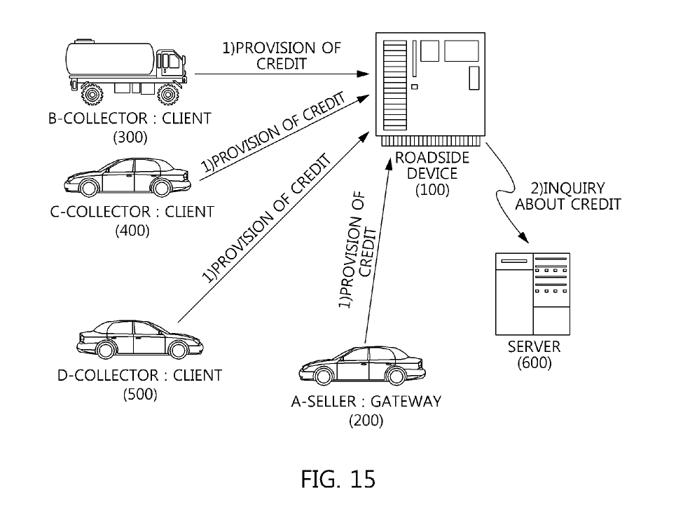

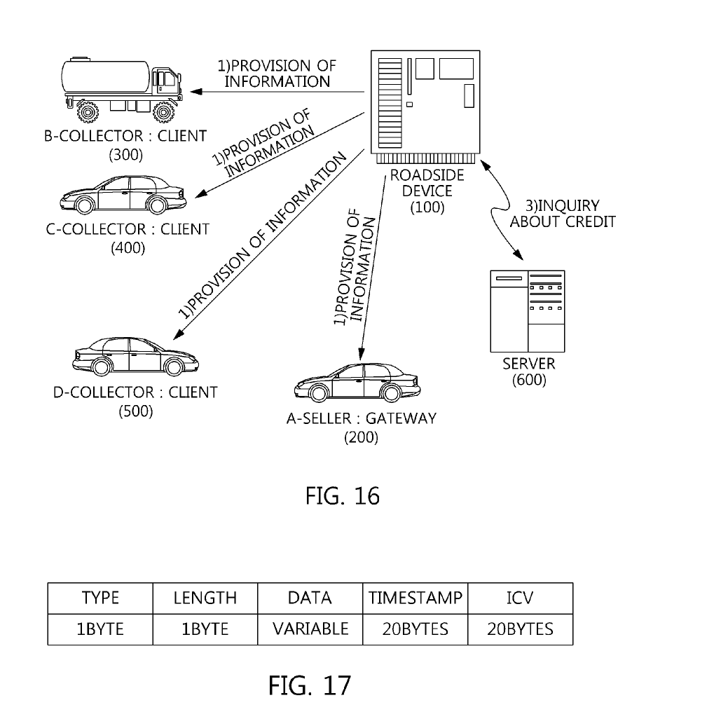

FIGS. 15 and 16 illustrate a configuration for providing a credit from a vehicle-mounted device and receiving an information service from the server 600. The vehicle-mounted device that has propagated advertising information, has been assigned a credit based on the processing of information collection and has stored it, as illustrated in FIGS. 12 and 14, may receive necessary information from the server 600 using the stored credit. The information received from the server 600 may be geographical information, map information, or nearby transport information that are indicated using latitude and longitude. When the vehicle-mounted device transmits information desired for reception and the corresponding credit, together with the ID of the vehicle-mounted device, to the roadside device 100, the roadside device 100 transmits them to the server 600. Since the server 600 stores a credit and provision information for each vehicle-mounted device, the server 600 inquires about a total credit amount for the corresponding vehicle-mounted device, subtracts a credit to be used from the total credit amount, records the details of use of the credit, and transmits identification information and the desired information for the vehicle-mounted device to the roadside device 100. Thereafter, the roadside device 100 transmits request information and information about the user of the credit to the vehicle-mounted device.

In order to perform communication and information transmission among the vehicle-mounted devices, the roadside device, and the server in the above-described information service system using direct communication between vehicles according to the present invention, a protocol for the format of messages to be exchanged is required. In the following description, a message format according to the present invention will be described.

FIG. 17 illustrates an example of a general message format that is used in the information service system using direct communication between vehicles according to the present invention. The message format that is described in connection with the present invention focuses on the configuration of fields that constitute messages, and the number of bits or bytes that are assigned to each field may vary as required. It should be noted that the following example is merely an example that is intended as an aid in understanding the features of the present invention.

The general message format illustrated in FIG. 17 includes message type, length, data, timestamp, and integrity check value (ICV) fields.

The message type field is used to identify the type of message. An example in which a length of 1 byte has been assigned to the message type is illustrated in FIG. 17. The types of messages that can be identified in accordance with the illustrated example are as follows:
0X01: IDEN—identification information type message format
0X02: DATA—information collection and provision type message format
0X03: ANNO—advertising type message format
0X11: IACK—identification information response type message format
0X12: DACK—information collection and provision response type message format
0X13: AACK—advertising response type message format

The length field indicates the number of pieces of TLV type information that each includes a type-length-value (TLV) in the data field (1 byte).

The data field includes TLVs, and has a form varying depending on the value of the type field (variable).

The timestamp field indicates time information, and is used to verify the validity of a corresponding message (20 bytes).

The ICV field indicates a hash-based message authentication code that is used to check the integrity of the message (20 bytes).

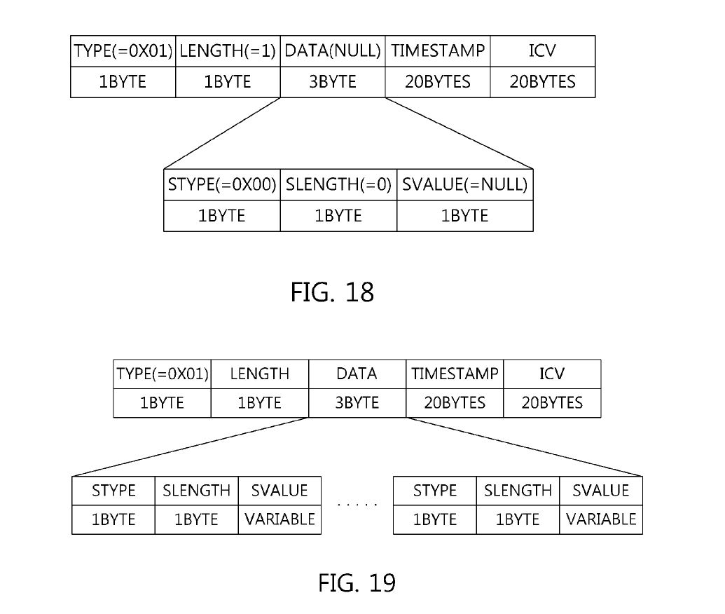

FIG. 18 illustrates an example of an IDEN type message format based on the general message format of FIG. 17.

In the IDEN type message format, the type field is set to 0X01, and the length field is set to “1.” Accordingly, the data field corresponds to a length field value of “1,” that is, the number of pieces of TLV type information that each includes a sType-sLength-sValue (TLV) is one. The sType field that constitutes part of the TLV type information has a value of “0X00,” which indicates that null values are included therein. Furthermore, the sLength field of the TLV type information is set to “0,” which indicates that there is no TLV in the sValue field. Accordingly, the sValue field has a null value, which is set to “0” of 1 byte.

FIG. 19 illustrates an example of an IACK type message format based on the general message format of FIG. 17.

In the IACK type message format, the length field indicates the total number of sType-sLength-sValues (TLVs) that constitute the data field. The sType field of the data field indicates one of the following types depending on its value:
0X01: the unique name information of a client
0X02: the certificate of a client
0X03: the security specification information of a client

The sLength field indicates the total number of TLVs (sType-sLength-sValues) that constitute the data field. The length of the sValue field is determined and set depending on the type of information that is indicated in the sType field.

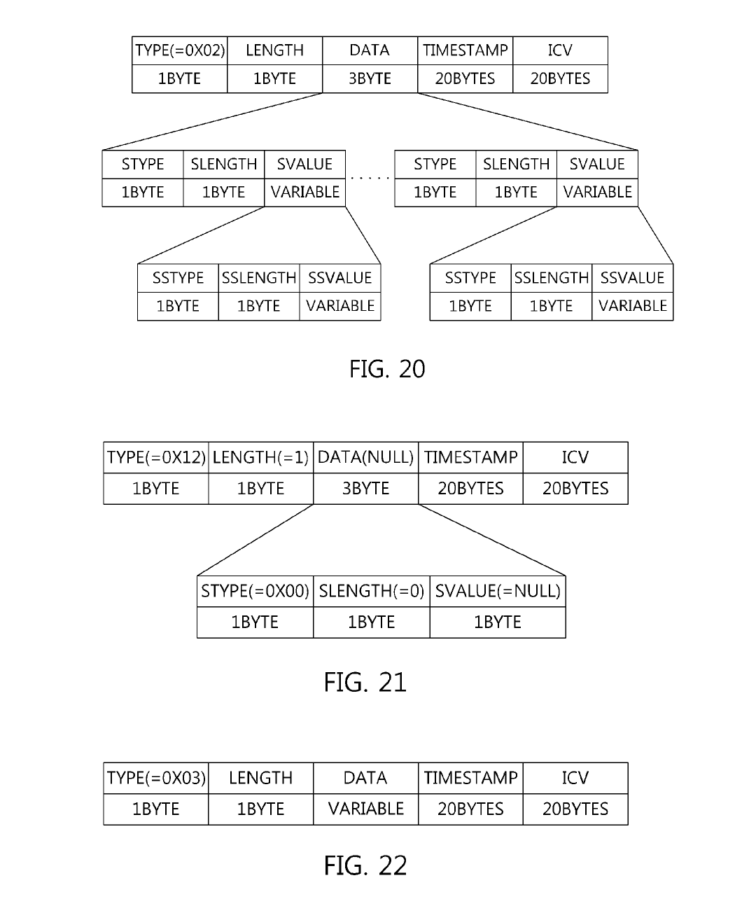

FIG. 20 illustrates an example of a DATA type message format based on the general message format of FIG. 17.

In the DATA type message format, the length field indicates the total number of sType-sLength-sValues (TLVs) that constitute the data field. The sType field of the data field indicates one of the following types depending on its value:
0X01: video information
0X02: text information
0X03: audio information
0X04˜0XFE: reserved
0XFF: list

The sLength indicates that the total number of sType-sLength-sValues (TLVs) that constitute the data field is “1,” and the sValue field is set to a value that is determined depending on the type of information that is indicated in the sType field.

Accordingly, in the sValue field of the DATA type message format, the type-length-value information is assigned to the ssType, ssLength and ssValue fields. The ssType field indicates one of the following types depending on its value:
ssType=0X01: in the case of video information, ssType identifies the type of video (for example, mpeg, wmv avi, mkv, . . . )
ssType=0X02: in the case of text information, ssType indicates a rainfall, temperature, humidity, latitude, longitude, speed, or the like
ssType=0X03: in the case of audio information, ssType identifies the type of audio (for example, mp3, wma, . . . )

The ssLength field indicates the total number of TLVs that constitute the data field, and the ssValue field is set to a value that is determined depending on the type of information that is indicated in the sType field.

FIG. 21 illustrates an example of a DACK type message format based on the general message format of FIG. 17.

In the DACK type message format, the type field is set to 0X12, and the length field is set to “1,” which indicates that the data field includes only a single TLV. Accordingly, the sType field that constitutes part of the TLV type information has a value of “0X00,” which indicates that null values are included therein. Furthermore, the sLength field of the TLV type information is set to “0,” which indicates that there is no TLV in the sValue field. Accordingly, the sValue field has a null value, and is set to “0” of 1 byte.

FIG. 22 illustrates an example of an ANNO type message format based on the general message format of FIG. 17. In the ANNO type message format, the type field is set to 0X03, and the data field is set in the same manner as that of the DATA type message format. The sType field of the data field is set to 0XFF (list). The ssType field indicates one of the following types depending on its value:
0X01: ID information assigned by the server
0X02: IP address
0X03˜: reserved

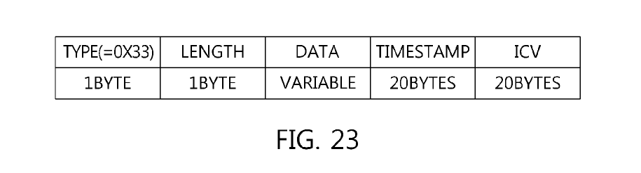

FIG. 23 illustrates an example of an AACK type message format based on the general message format of FIG. 17. In the AACK type message format, the type field is set to 0X33, and the data field is set in the same manner as that of the DATA type message format. Furthermore, the ssType field has the same form as that of the ANNO message format.

The information service system using direct communication between vehicles according to present invention is advantageous in that information can be provided from a server through a roadside device to vehicle-mounted devices and can be propagated via direct communication between the vehicle-mounted devices.

The information service system using direct communication between vehicles according to present invention is advantageous in that information can be collected from vehicle-mounted devices through a roadside device and can be provided to a server.

The information service system using direct communication between vehicles according to present invention is advantageous in that vehicle-mounted devices are assigned credits in return for the propagation of information provided from the server and the provision of information and can receive necessary information from the server using the credits.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An information service system using direct communication between vehicles for machine-to-machine (M2M)-based intelligent transport services (ITS), comprising at least one vehicle ITS station and at least one roadside device, the vehicle station and the roadside device exchanging information with a server, wherein the vehicle ITS station comprises:
an ITS-S host configured to perform overall control;
an ITS-S router configured to connect with a short or long distance communication network, to form a communication network, and to perform transmission and reception of data; and
a vehicle ITS-S gateway configured to provide data received from an outside of the vehicle ITS station, that is, data provided from an electronic control unit (ECU) or a variety of types of sensors on a vehicle; and
wherein the ITS-S host, the ITS-S router and the vehicle ITS-S gateway are connected over an ITS station-internal network, thereby forming a vehicle-mounted device.

2. The information service system of claim 1, wherein:
the vehicle ITS-S gateway provides the data received from the ECU or the variety of types of sensors on the vehicle; and
the ECU or the variety of types of sensors on the vehicle that provide data outside a vehicle-mounted device are connected to the vehicle ITS-S gateway via a proprietary in-vehicle network.

3. The information service system of claim 1, wherein the roadside device comprises:
an ITS-S host configured to perform overall control;
an ITS-S router configured to connect with a short or long distance communication network, to form a communication network, and to transmit and receive data to and from vehicles that are travelling along a road;
a roadside ITS-S gateway configured to provides the data received from the outside of the vehicle-mounted device, that is, the data received from the ECU or the variety of types of sensors, to the roadside device over a roadside network, and to display information received from the roadside device on variable message signs (VMS) via the roadside network; and
an ITS-S border router configured to connect roadside devices over a network and to connect the roadside devices to a central server for the ITS; and
wherein the ITS-S host, the ITS-S router, the roadside ITS-S gateway, and the ITS-S border router are connected over an ITS station-internal network.

4. An information service system using direct communication between vehicles for M2M-based ITS, comprising one or more vehicle-mounted devices as one or more vehicle ITS stations and at least one roadside device, the vehicle-mounted devices and the roadside device exchanging information with a server, wherein:
vehicles mounted with the vehicle-mounted devices having their own networking function transmit ID information requests to the roadside device;
the roadside device that has received the ID information requests transmits information about the ID information requests to a server of the information service system;
the server of the information service system that has received the information about the ID information requests assigns identification information for each of the vehicle-mounted devices and transmits the identification information and security information for each of the vehicle-mounted devices to the roadside device; and
the roadside device provides identification information and security information for each of the vehicle-mounted devices that have transmitted the ID information requests.

5. The information service system of claim 4, wherein:
if a vehicle ITS-S gateway of each of the vehicle-mounted devices comprises a communication module capable of communicating with an external network and thus has an Internet Protocol (IP) networking function,
the vehicle-mounted device transmits the IP information request to the server via direct communication, and
the server of the information service system directly transmits the identification information and the security information to the vehicle-mounted device.

6. The information service system of claim 4, wherein:
the server transmits advertising information to the roadside device;
the roadside device provides the advertising information, together with an information request, to a first at least one adjacent vehicle mounted with the vehicle-mounted device;
the first at least one adjacent vehicle mounted with the vehicle-mounted device that has received the advertising information transmits the received advertising information, along with an assigned ID, to a second at least one adjacent vehicle; and
the second at least one adjacent vehicle that has received the advertising information transmits advertising information including an assigned ID of its vehicle-mounted device and the ID included in the received advertising information to a third at least one adjacent vehicle.

7. The information service system of claim 6, wherein:
if the advertising information has been transmitted to the vehicles having the vehicle-mounted devices,
the vehicle-mounted device of each of the vehicles transmits a list for processing of the advertising information to the roadside device,
the list includes identification information of the vehicle-mounted device to which the advertising information has been transferred,
the identification information of all vehicle-mounted devices that have propagated the advertising information is included in the list, and
the roadside device that has received the list from each of the vehicles mounted with the vehicle-mounted devices provides the list to the server of the information service system.

8. The information service system of claim 7, wherein the roadside device that has received the list:
calculates a number of transmissions of the advertising information based on the list for each of the vehicle-mounted devices; and
calculates a credit for each of the vehicle-mounted devices based on results of the former calculation, and transmits the credit for each of the vehicle-mounted devices to the server and to the corresponding vehicle-mounted device.

9. The information service system of claim 4, wherein:
data that is provided from each of vehicles mounted with the vehicle-mounted devices to the roadside device is transmitted along with an ID of the vehicle-mounted device;
the data that is received from the vehicle includes all data for the ITS, and includes information, such as temperature, humidity, vehicle speed, distance between vehicles, and the like; and
the roadside device that has received the data from the vehicle provides the received information and the ID of the vehicle-mounted device to the server of the information service system in a list form, so that they are stored in the server.

10. The information service system of claim 9, wherein:
the server that stores the data that is received from the vehicle and the ID of the vehicle-mounted device that has provided the data in the list form assigns a credit to each of the vehicle-mounted devices depending on the importance of the provided information, and transmits the credit to the roadside device;
the roadside device transmits the credit to the vehicle-mounted device; and
the vehicle-mounted device that has received the credit stores the received credit therein.

11. The information service system of claim 10, wherein:
the vehicle-mounted device that has received the credit transmits information desired for reception and the received credit, together with the ID of the vehicle-mounted device, to the roadside device;
the roadside device transmits the received data to the server;
the server inquires about a total credit amount for the vehicle-mounted device, subtracts a credit used from the total credit amount, and records the remaining credit, and transmits identification information and the desired information for the vehicle-mounted device to the roadside device; and
the roadside device transmits the desired information and information about the use of the credit to the vehicle-mounted device.

12. An information service system using direct communication between vehicles for M2M-based ITS, comprising at least one vehicle ITS station and at least one roadside device, the vehicle station and the roadside device exchanging information with a server, wherein:
an ITS-S host, an ITS-S router and a vehicle ITS-S gateway of the vehicle ITS station use messages to exchange information with each other;
a message format of the messages includes message type, length, data, timestamp, and Integrity Check Value (ICV) fields;
the message type field indicates one of an identification information (IDEN) type message format, an information collection and provision (DATA) type message format, an advertising (ANNO) type message format, an identification information response (IACK) type message format, an information collection and provision response (DACK) type message format, and an advertising response (AACK) type message format;
the length field indicates a number of pieces of TLV type information that each includes a type-length-value (TLV) in the data field;
the data field includes TLVs, and has a form varying depending on a value of the type field;
the timestamp field indicates time information, and is used to verify validity of a corresponding message; and
the ICV field indicates a hash-based message authentication code that is used to check the integrity of the message.

13. The information service system of claim 12, wherein the IDEN type message format comprises:
a length field set to “1,” so that a number of pieces of TLV type information that each includes a sType-sLength-sValue (TLV) is one;
an sType field configured to constitute part of the TLV type information, and to indicate that null values are included therein; and
an sLength field of the TLV type information set to “0,” and configured to indicate that there is no TLV in an sValue field, so that the sValue field has a null value.

14. The information service system of claim 12, wherein the IACK type message format comprises:
a length field configured to indicate a total number of sType-sLength-sValues (TLVs) that constitute a data field;
an sType field of the data field configured to classified as one of unique name information of a client, a certificate of the client, and security specification information of the client depending on its value:
an sLength field configured to indicate a total number of TLVs (sType-sLength-sValues) that constitute a data field; and
a length of the sValue field configured to be determined and set depending on a type of information that is indicated in the sType field.

15. The information service system of claim 12, wherein the DATA type message format comprises:
a length field configured to indicate a total number of sType-sLength-sValues (TLVs) that constitute a data field;
an sType field of the data field configured to indicate one of video information, text information, audio information, and list types depending on its value;
an sLength configured so that a total number of sType-sLength-sValues (TLVs) that constitute a data field is “1”; and
an sValue field set to a value that is determined depending on a type of information that is indicated in the sType field;
wherein in the sValue field of the DATA type message format, the type-length-value information is assigned to the ssType, ssLength, and ssValue fields;
wherein the ssType field indicates one of an ssType configured such that in the case of video information, the ssType indicates a type of video, an ssType configured such that in the case of text information, the ssType indicates a rainfall, temperature, humidity, latitude, longitude, speed, or the like, and an ssType configured such that in the case of audio information, the ssType indicates a type of audio;
wherein the ssLength field indicates a total number of TLVs that constitute the data field; and
wherein the ssValue field is set to a value that is determined depending on a type of information that is indicated in the sType field.

16. The information service system of claim 12, wherein the DACK type message format comprises:
a length field set to “1,” so that a data field includes only a single TLV;
an sType field configured to constitute part of TLV type information, and to indicate that null values are included therein;
an sLength field of the TLV type information set to “0” and configured to indicate that there is no TLV in an sValue field; and
an sValue field set to a null value.

17. The information service system of claim 12, wherein the ANNO type message format comprises:
a data field set in a same manner as that of the DATA type message format;
an sType field of the data field set to a list value; and
an ssType field configured to indicate one of ID information assigned by the server and an IP address depending on its value.

18. The information service system of claim 12, wherein the AACK type message format comprises:
a data field set in a same manner as that of the DATA type message format; and
an ssType field configured to have a same form as that of the ANNO message format.
